(19) United States
(12) Patent Application Publication
(10) Pub. No.: US 2020/0159195 A1
(43) Pub. Date: May 21, 2020

(54) SELECTIVE DATA FEEDBACK FOR INDUSTRIAL EDGE SYSTEM

(71) Applicant: General Electric Company, Schenectady, NY (US)

(72) Inventors: Xiao BIAN, Niskayuna, NY (US); Colin PARRIS, Brookfield, CT (US); Dayu HUANG, Niskayuna, NY (US); Huan TAN, Clifton Park, NY (US); Kiersten RALSTON, Niskayuna, NY (US); Shaopeng LIU, Niskayuna, NY (US); Guiju SONG, Niskayuna, NY (US)

(21) Appl. No.: 16/192,968

(22) Filed: Nov. 16, 2018

(51) Int. Cl. G05B 19/418; G06N 99/00

(52) U.S. Cl. CPC G05B 19/41855; G05B 2219/31457; G06N 99/005

(57) ABSTRACT

The example embodiments are directed to a system and method for optimizing data the is transmitted from an edge device to a central server such as the cloud platform. In one example, the method may include one or more of receiving incoming data which is associated with an industrial asset positioned at an edge of an Internet of Things (IoT) network, transforming the incoming data into a pattern of data points within a feature space based on a machine learning model configured to detect patterns within the data, selecting a subset of data points from the pattern based on a distance between data points in the pattern of data points with respect to a previous pattern of data points in a previous dataset associated with the industrial asset, and transmitting the selected subset of data points to a central platform via the IoT network.

### BACKGROUND

Machine and equipment assets are engineered to perform particular tasks as part of a process. For example, assets can include, among other things, industrial manufacturing equipment on a production line, drilling equipment for use in mining operations, wind turbines that generate electricity on a wind farm, transportation vehicles (trains, subways, airplanes, etc.), gas and oil refining equipment, and the like. As another example, assets may include devices that aid in diagnosing patients such as imaging devices (e.g., X-ray or MM systems), monitoring equipment, and the like. The design and implementation of these assets often takes into account both the physics of the task at hand, as well as the environment in which such assets are configured to operate.

Low-level software and hardware-based controllers have long been used to drive machine and equipment assets. However, the overwhelming adoption of cloud computing, increasing sensor capabilities, and decreasing sensor costs, as well as the proliferation of mobile technologies, have created opportunities for creating novel industrial and healthcare based assets with improved sensing technology and which are capable of transmitting data that can then be distributed throughout a network. As a consequence, there are new opportunities to enhance the business value of some assets through the use of novel industrial-focused hardware and software.

An industrial internet of things (IIoT) network incorporates machine learning and big data technologies to harness the sensor data, machine-to-machine (M2M) communication and automation technologies that have existed in industrial settings for years. The driving philosophy behind IIoT is that smart machines are better than humans at accurately and consistently capturing and communicating real-time data. This data enables companies to pick up on inefficiencies and problems sooner, saving time and money and supporting business intelligence (BI) efforts. IIoT holds great potential for quality control, sustainable and green practices, supply chain traceability and overall supply chain efficiency.

In an IIoT, edge devices sense or otherwise capture data and submit the data to a cloud platform or other central host. Data provided from edge devices may be used in a large variety of industrial applications. In a cloud-edge system, artificial intelligence (AI) models having machine learning capabilities are maintained in the cloud and operated based on key information that is collected from different edge devices. For example, one or more AI models supported by the cloud can be used to identify issues with an industrial asset such as structural damage, changes in operating characteristics, machine controls that need to be changed, and the like. However, bandwidth between an edge device and a cloud platform is limited. Also, a significant amount of data captured by the edge is redundant or lacks identifying features. Therefore, a mechanism is needed which can optimize data transmission between the edge and the cloud while still ensuring that enough data is provided to accurately run the AI models.

### SUMMARY

According to an aspect of an example embodiment, a computing system may include one or more of a storage configured to store incoming data which is associated with an industrial asset positioned at an edge of an IoT network, a processor configured to transform the incoming data into a pattern of data points within a feature space based on a machine learning model configured to detect patterns within the data, and select a subset of data points from the pattern based on a distance between data points in the pattern of data points with respect to a previous pattern of data points in a previous dataset associated with the industrial asset, and a network interface configured to transmit the selected subset of data points to a central platform via the IoT network.

According to an aspect of another example embodiment, a method may include one or more of receiving incoming data which is associated with an industrial asset positioned at an edge of an Internet of Things (IoT) network, transforming the incoming data into a pattern of data points within a feature space based on a machine learning model configured to detect patterns within the data, selecting a subset of data points from the pattern based on a distance between data points in the pattern of data points with respect to a previous pattern of data points in a previous dataset associated with the industrial asset, and transmitting the selected subset of data points to a central platform via the IoT network.

Other features and aspects may be apparent from the following detailed description taken in conjunction with the drawings and the claims.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating a cloud computing system for industrial software and hardware in accordance with an example embodiment.

FIG. 2 is a diagram illustrating a process of an edge device transmitting subsets of data to a cloud platform in accordance with an example embodiment.

FIG. 3A is a graph illustrating incoming clusters of data transformed into feature space in accordance with example embodiments.

FIG. 3B is a graph illustrating a distance between a center of a cluster and a new data point in Euclidean space in accordance with example embodiments.

FIG. 4 is a diagram illustrating a method for selecting a subset of incoming data to be fed back in accordance with an example embodiment.

FIG. 5 is a diagram illustrating a computing system configured for use within any of the example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

The example embodiments are directed to a system which controls the amount of data and the quality of data about an industrial asset that is transmitted from an edge device to a central platform. Within the system, edge devices and the cloud platform may use machine learning (ML) models (also referred to as artificial intelligence models) to monitor and predict attributes associated with the industrial asset. Often, these models are processed on the cloud based on data that is fed back from edge devices which collect data from sensors on or about the industrial asset. For example, sensors may capture time-series data (temperature, pressure, vibration, etc.) about an industrial asset which can be processed using ML models to identify operating characteristics of the industrial asset that need to be changed. As another example, images may be captured of an industrial asset which can be processed using ML models to identify various image features or regions of interest (e.g., damage, wear, tear, etc.) to the industrial asset. In order for these models to operate accurately, the models must receive.

However, bandwidth between the edge and the cloud is limited. Therefore, sending back each image or other sequence of data captured at the edge creates significant expense because it consumes large amounts of network bandwidth and operating resources. The example embodiments provide a technical solution to these drawbacks by optimizing the amount and the quality of the data that is sent from an edge device to a cloud platform. An industrial site may include multiple sensors and other acquiring systems that capture data of an industrial asset being operated. An edge device receiving incoming data sensed from or about the asset may select a subset of the data to send back to the cloud. The subset of the data is selected based on the distance between data points captured during the current data sequence with respect to data points captured previously (or historically). When the data points in the current sequence are far away from data points in a previous sequence, the current data sequence is capturing new information that is relevant for the cloud system. However, if the distance is close then the incoming data is a repeat or similar to the previous data, and is not valuable because the new information provided is minimal.

ML models may be used to evaluate data captured by the edge with respect to a trained/reference set of data that is usually a base line of a performance of the asset. For example, ML models may be used to identify discriminate features which can be used to make predictions about an industrial asset such as when wear or damage has occurred to an asset, if instrument controls need to be changed based on external factors, if a part needs replacement, if materials should be ordered, and the like. For example, ML models may operate based on time-series data, images, audio, and the like, which may be captured by sensors (pressure, acoustic, temperature, motion, imaging, acoustic, etc.), and the like. An ML model may map a set of raw data into a plurality of data points within a feature space. The data points in the feature space may be analyzed to make predictions about the asset such as operating characteristics, damage, etc.

In the example of image data, the image data may be attempting to detect a specific feature from an industrial asset (e.g., damage to a surface of the asset, etc.) A machine learning model may be trained to identify how likely such a feature exists in an image. A result of the ML model output may be a data point for the image where the data point is arranged in a multi-dimensional feature space with a likelihood of the feature existing within the image being arranged on one axis (e.g., y axis) and time on another axis (e.g., x axis). As another example, time-series data may be used to monitor how a machine or equipment is operating over time. Time-series data may include temperature, pressure, speed, etc. Here, the ML model may be trained to identify how likely it is that the operation of the asset is normal or abnormal based on the incoming-time series data.

According to various embodiments, data captured from the industrial asset may be received in raw form and converted into feature space by an ML model. The data may be processed in clusters or segments. Each data point in a cluster may represent an image captured by a camera or a reading sensed by a sensor. The edge system may convert the raw data into data points within the feature space using an ML model. The resulting data points may be graphed as a pattern of data that can be compared with a pattern of data of a previous data cluster. When a distance between data points in the current cluster and data points in a previous cluster is greater than a predefined threshold, the data may be sent back to the cloud platform by the edge system. However, when data is not greater than the predefined threshold, the data may not be sent back thereby conserving network resources.

The system and method described herein may be implemented via a program or other software that may be used in conjunction with applications for managing machine and equipment assets hosted within an industrial internet of things (IIoT). An IIoT may connect assets, such as turbines, jet engines, locomotives, elevators, healthcare devices, mining equipment, oil and gas refineries, and the like, to the Internet or cloud, or to each other in some meaningful way such as through one or more networks. The cloud can be used to receive, relay, transmit, store, analyze, or otherwise process information for or about assets and manufacturing sites. In an example, a cloud computing system includes at least one processor circuit, at least one database, and a plurality of users and/or assets that are in data communication with the cloud computing system. The cloud computing system can further include or can be coupled with one or more other processor circuits or modules configured to perform a specific task, such as to perform tasks related to asset maintenance, analytics, data storage, security, or some other function.

Assets may be outfitted with one or more sensors (e.g., physical sensors, virtual sensors, etc.) configured to monitor respective operations or conditions of the asset and the environment in which the asset operates. Data from the sensors can be recorded or transmitted to a cloud-based or other remote computing environment. By bringing such data into a cloud-based computing environment, new software applications informed by industrial process, tools and know-how can be constructed, and new physics-based analytics specific to an industrial environment can be created. Insights gained through analysis of such data can lead to enhanced asset designs, enhanced software algorithms for operating the same or similar assets, better operating efficiency, and the like.

The edge-cloud system may be used in conjunction with applications and systems for managing machine and equipment assets and can be hosted within an IIoT. For example, an IIoT may connect physical assets, such as turbines, jet engines, locomotives, healthcare devices, and the like, software assets, processes, actors, and the like, to the Internet or cloud, or to each other in some meaningful way such as through one or more networks. The system described herein can be implemented within a “cloud” or remote or distributed computing resource. The cloud can be used to receive, relay, transmit, store, analyze, or otherwise process information for or about assets. In an example, a cloud computing system includes at least one processor circuit, at least one database, and a plurality of users and assets that are in data communication with the cloud computing system. The cloud computing system can further include or can be coupled with one or more other processor circuits or modules configured to perform a specific task, such as to perform tasks related to asset maintenance, analytics, data storage, security, or some other function.

While progress with industrial and machine automation has been made over the last several decades, and assets have become ‘smarter,’ the intelligence of any individual asset pales in comparison to intelligence that can be gained when multiple smart devices are connected together, for example, in the cloud. Aggregating data collected from or about multiple assets can enable users to improve business processes, for example by improving effectiveness of asset maintenance or improving operational performance if appropriate industrial-specific data collection and modeling technology is developed and applied.

The integration of machine and equipment assets with the remote computing resources to enable the IIoT often presents technical challenges separate and distinct from the specific industry and from computer networks, generally. To address these problems and other problems resulting from the intersection of certain industrial fields and the IIoT, the example embodiments provide a mechanism for triggering an update to a ML model upon detection that the incoming data is no longer represented by the data pattern within the training data which was used to initially train the ML model.

The Predix™ platform available from GE is a novel embodiment of such an Asset Management Platform (AMP) technology enabled by state of the art cutting edge tools and cloud computing techniques that enable incorporation of a manufacturer's asset knowledge with a set of development tools and best practices that enables asset users to bridge gaps between software and operations to enhance capabilities, foster innovation, and ultimately provide economic value. Through the use of such a system, a manufacturer of industrial or healthcare based assets can be uniquely situated to leverage its understanding of assets themselves, models of such assets, and industrial operations or applications of such assets, to create new value for industrial customers through asset insights.

As described in various examples herein, data may include a raw collection of related values of an asset or a process/operation including the asset, for example, in the form of a stream (in motion) or in a data storage system (at rest). Individual data values may include descriptive metadata as to a source of the data and an order in which the data was received, but may not be explicitly correlated. Information may refer to a related collection of data which is imputed to represent meaningful facts about an identified subject. As a non-limiting example, information may be a dataset such as a dataset which has been determined to represent temperature fluctuations of a machine part over time.

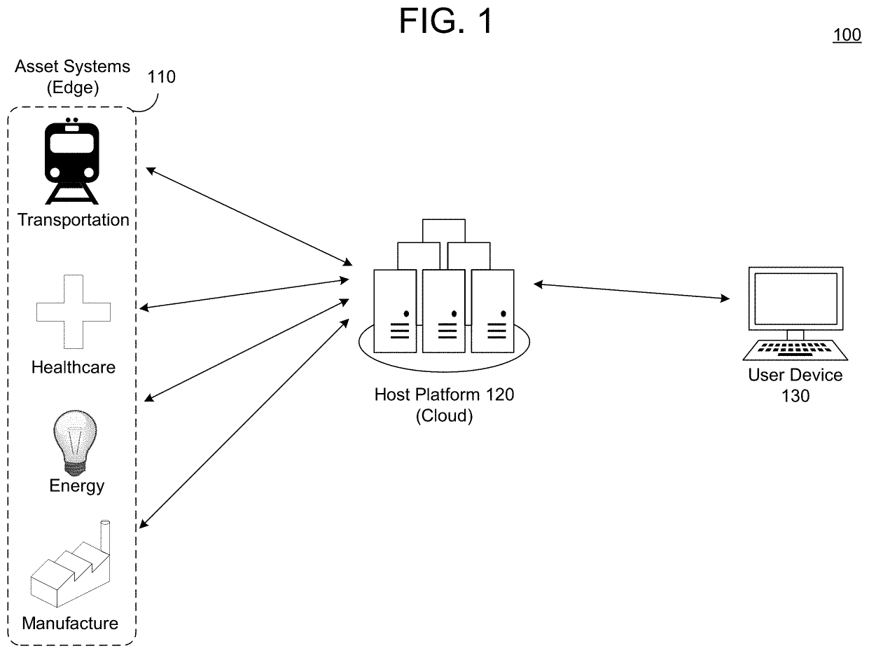

FIG. 1 illustrates a cloud computing system 100 for industrial software and hardware in accordance with an example embodiment. Referring to FIG. 1, the system 100 includes a plurality of assets 110 which may be included within an edge of an IIoT and which may transmit raw data to a source such as cloud computing platform 120 where it may be stored and processed. It should also be appreciated that the cloud platform 120 in FIG. 1 may be replaced with or supplemented by a non-cloud based platform such as a server, an on-premises computing system, and the like. Assets 110 may include hardware/structural assets such as machine and equipment used in industry, healthcare, manufacturing, energy, transportation, and that like. It should also be appreciated that assets 110 may include software, processes, actors, resources, and the like. A digital replica (i.e., a digital twin) of an asset 110 may be generated and stored on the cloud platform 120. The digital twin may be used to virtually represent an operating characteristic of the asset 110.

The data transmitted by the assets 110 and received by the cloud platform 120 may include raw time-series data output as a result of the operation of the assets 110, and the like. Data that is stored and processed by the cloud platform 120 may be output in some meaningful way to user devices 130. In the example of FIG. 1, the assets 110, cloud platform 120, and user devices 130 may be connected to each other via a network such as the Internet, a private network, a wired network, a wireless network, etc. Also, the user devices 130 may interact with software hosted by and deployed on the cloud platform 120 in order to receive data from and control operation of the assets 110.

Software and hardware systems can be used to enhance or otherwise used in conjunction with the operation of an asset and a digital twin of the asset (and/or other assets), may be hosted by the cloud platform 120, and may interact with the assets 110. For example, ML models (or AI models) may be used to optimize a performance of an asset or data coming in from the asset. As another example, the ML models may be used to predict, analyze, control, manage, or otherwise interact with the asset and components (software and hardware) thereof. The ML models may also be stored in the cloud platform 120 and/or at the edge (e.g. asset computing systems, edge PC's, asset controllers, etc.)

A user device 130 may receive views of data or other information about the asset as the data is processed via one or more applications hosted by the cloud platform 120. For example, the user device 130 may receive graph-based results, diagrams, charts, warnings, measurements, power levels, and the like. As another example, the user device 130 may display a graphical user interface that allows a user thereof to input commands to an asset via one or more applications hosted by the cloud platform 120.

In some embodiments, an asset management platform (AMP) can reside within or be connected to the cloud platform 120, in a local or sandboxed environment, or can be distributed across multiple locations or devices and can be used to interact with the assets 110. The AMP can be configured to perform functions such as data acquisition, data analysis, data exchange, and the like, with local or remote assets, or with other task-specific processing devices. For example, the assets 110 may be an asset community (e.g., turbines, healthcare, power, industrial, manufacturing, mining, oil and gas, elevator, etc.) which may be communicatively coupled to the cloud platform 120 via one or more intermediate devices such as a stream data transfer platform, database, or the like.

Information from the assets 110 may be communicated to the cloud platform 120. For example, external sensors can be used to sense information about a function, process, operation, etc., of an asset, or to sense information about an environment condition at or around an asset, a worker, a downtime, a machine or equipment maintenance, and the like. The external sensor can be configured for data communication with the cloud platform 120 which can be configured to store the raw sensor information and transfer the raw sensor information to the user devices 130 where it can be accessed by users, applications, systems, and the like, for further processing. Furthermore, an operation of the assets 110 may be enhanced or otherwise controlled by a user inputting commands though an application hosted by the cloud platform 120 or other remote host platform such as a web server. The data provided from the assets 110 may include time-series data or other types of data associated with the operations being performed by the assets 110

In some embodiments, the cloud platform 120 may include a local, system, enterprise, or global computing infrastructure that can be optimized for industrial data workloads, secure data communication, and compliance with regulatory requirements. The cloud platform 120 may include a database management system (DBMS) for creating, monitoring, and controlling access to data in a database coupled to or included within the cloud platform 120. The cloud platform 120 can also include services that developers can use to build or test industrial or manufacturing-based applications and services to implement IIoT applications that interact with assets 110.

For example, the cloud platform 120 may host an industrial application marketplace where developers can publish their distinctly developed applications and/or retrieve applications from third parties. In addition, the cloud platform 120 can host a development framework for communicating with various available services or modules. The development framework can offer developers a consistent contextual user experience in web or mobile applications. Developers can add and make accessible their applications (services, data, analytics, etc.) via the cloud platform 120. Also, analytic software may analyze data from or about a manufacturing process and provide insight, predictions, and early warning fault detection.

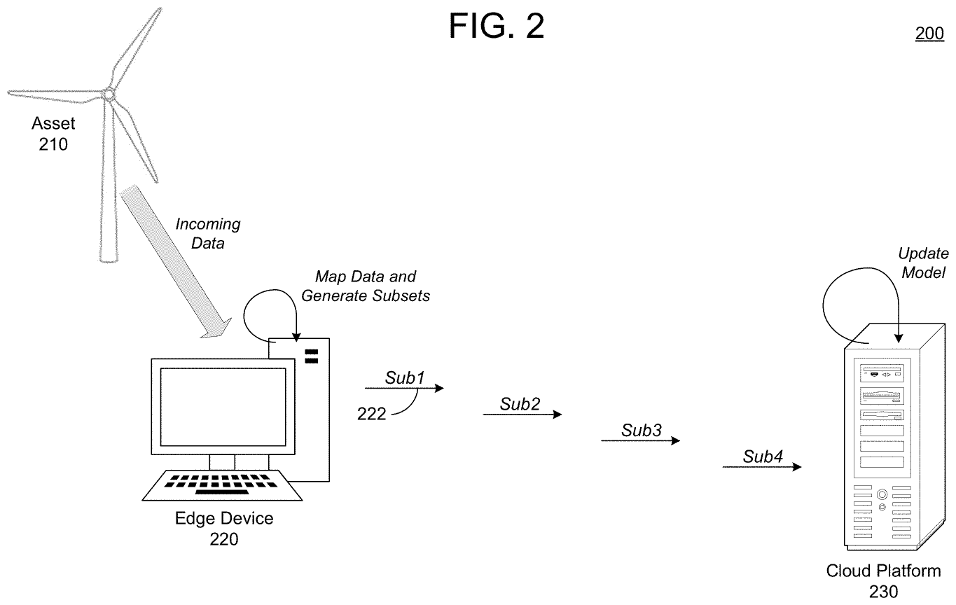

FIG. 2 illustrates a process 200 of an edge device 220 receiving incoming data from an industrial asset 210 and transmitting subsets of the data to a cloud platform 230 in accordance with an example embodiment. Although shown as a wind turbine, the industrial asset 210 may include any desirable asset such as a jet airplane, a locomotive, an elevator, a mining/drilling system, a gas flare stack, and the like. In this example, the asset 210 (or sensors sensing data of the asset 210) is coupled to (e.g., via a wired or wireless communication) the edge device 220. The edge device 220 may feed data to the cloud platform 230 at periodic or continuous intervals.

In some cases, the ML models may be stored on the edge device 220 attached or connected to the asset 210. The edge device 220 may receive views of data or other information about the asset as the data is captured by the sensors, cameras, gauges, etc. The cloud platform may also store and execute ML models associated with the operation of the industrial asset 210. As one example, the edge device 220 may store a ML model that is specific to the industrial asset 210 to which the edge device 220 is connected, and the cloud platform 230 may store a collaborative ML model which is generic to multiple assets or a farm of assets including the asset 210.

Referring to FIG. 2, data sensed in association with the industrial asset 210 may be provided as incoming data to the edge device 220. Here, the edge device 220 may be an industrial edge PC, an asset controller, an intervening edge server, a user device, an on-premises server, and the like. The edge device 220 may map the incoming data into a features space based on one or more ML models (AI models) which are used to detect features associated with the industrial asset 210. For example, the modeled data may be used to identify operating characteristics of an operation of the industrial asset 210. As another example, the modeled data may be used to identify damage or other regions of interest within image data. The modeled data may include data points mapped within feature space.

Rather than sending all of the data back to the cloud platform 230, the edge device 220 may optimize the amount of data and the quality of data that is sent back by only sending back a subset 222 of data in intervals (e.g., regular, periodic, random, etc.) In this example, the edge device 220 may be connected (wired or wirelessly) to physical sensors that can sense data about an operation of the industrial asset 210 (time-series data) or sense images of an outer appearance of the industrial asset 210. For example, the sensors can include various types of industrial devices such as imaging, proximity, temperature, switch, chemical, IR, pressure, counter, vibration, etc. The sensory information may be preprocessed following standard protocol and a standard data structure may be created to store the preprocessed data. After preprocessing, noises, errors, and inconsistent sampled data may be discarded to ensure the quality of the data set.

The edge device 220 may act as an interface or a bridge between the physical domain (raw data) and digital domain (transformed/mapped data in feature space). In this example, the edge device 220 can use sensors to obtain data from the industrial asset 210 and/or the surrounding environment. The data collection can be synchronized or asynchronous with respect to other edge devices (not shown), based on the requirements of the computing or operation tasks. In some cases, a group of sensors may connect data from the industrial asset 210 based on desired requirements. The sensed data may be converted into feature space based on ML models and subsets 222 may be sent to the cloud platform 230. In response, the cloud platform 230 may collaborate data from multiple edge devices, update models, execute collaborative (community) models, and the like, based on the subsets 222.

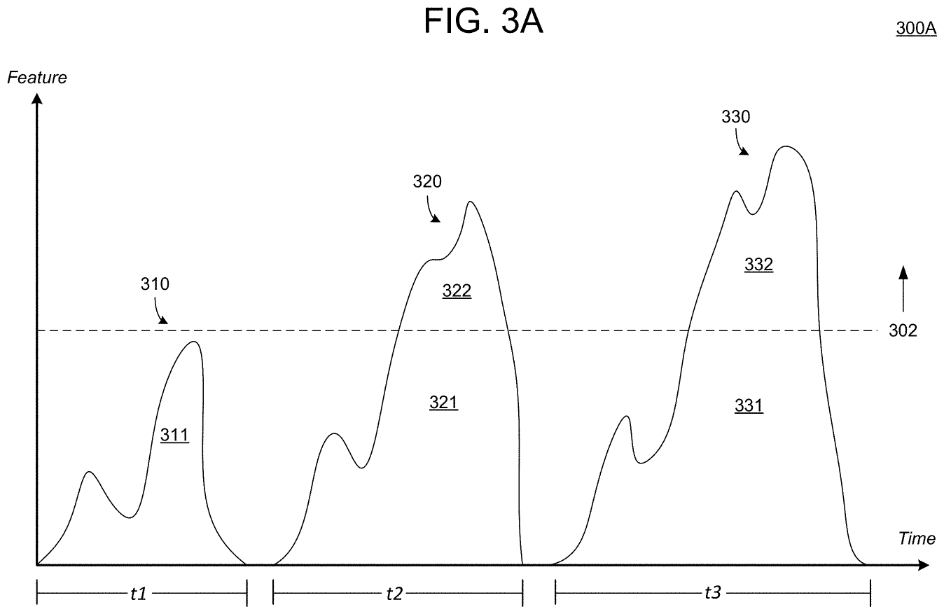

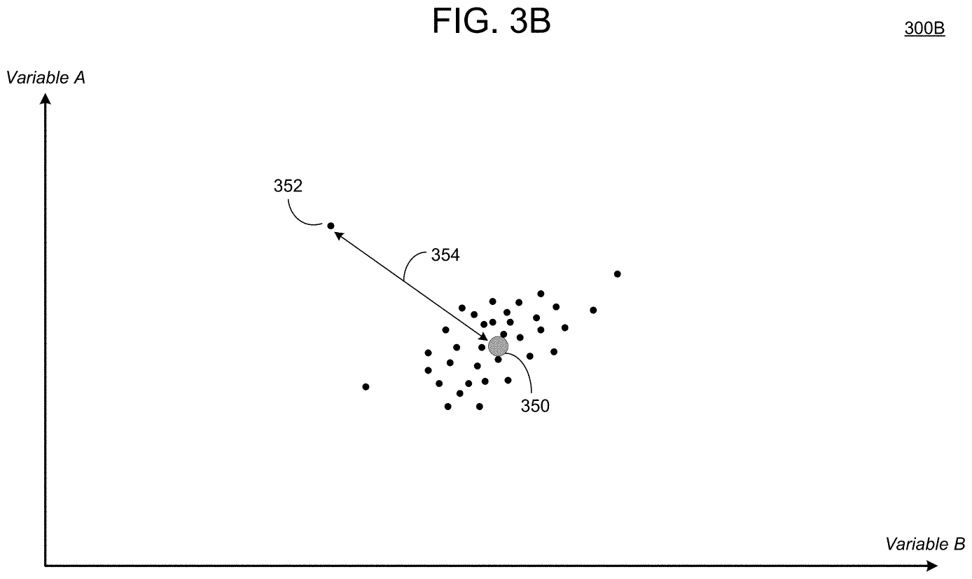

The example embodiments process the collected data in clusters such as shown in the examples of FIGS. 3A-3B which includes clusters 310, 320, and 330. The goal of the system is to process the collected data in clusters and further processed to generate high level features. One major innovation in this invention is to embed the concept of cluster processing or computing on different layer of the whole system. This approach can help provide better processing and better understanding of the environment. In these examples, the data at a higher layer may be abstracted at higher level. The assumption is that, the higher abstracted data requires smaller bandwidth for processing and communication. After preprocessing, data may be stored on the edge device 220 and transferred either to a central node such as the cloud platform 230 for clustered processing with data from other edge devices or gathered together for distributed and coordinated processing by an intervening edge server, asset controller, industrial PC, or the like.

In these embodiments, the system may be fully distributed or may have a central node. In an example of a fully distributed system, each edge device may maintain a stack of historical data with a cluster ID updated regularly using message passing. Using this approach, a plurality of edge devices may have independent processing functions, and the processed sensory data may be labeled and further processed based on cluster IDs. In an example in which the system includes a central node such as the cloud platform, the data may first be filtered out by each edge device, and then transfer to the central cloud node to form the hierarchical cluster. A bottom-up information flow or data flow is implemented to build a layered data structure. The data processing in either mode may generate data or features at different levels. The data may be stored on an edge server or stored in a distributed manner among the edge devices. The data structure and features may be updated continuously based on the incoming continuous sampled data.

In some embodiments, current communication bandwidths between edge systems and the cloud may be monitored continuously. The bandwidth may be determined by the workload of the cloud server and the edge devices, network communication bandwidth, storage and processing power of devices, and the like. Then based on the optimization goal described in equation (1) and (2) shown below, a slice or a level of the feature data may be determined by solving the equations. The feature data may be adaptively transmitted to the cloud sever for further processing. The system may also include a feedback loop to monitor the performance of transmitting data and processing data in the cloud. The feedback signal may help the system to continuously solve equation (1) and (2) to find an optimal solution to transmit data.

FIG. 3A is a graph 300A that illustrates incoming data transformed into feature space in accordance with example embodiments. Given limited communication bandwidth within an IoT network such as an IIoT, collocated edge devices of a same type may collaboratively filter out information and pass more important pieces of information to the cloud while preventing other pieces of information that are less beneficial (redundant, etc.) from being transmitted. Additionally, this process has to be dynamic due to the intrinsic data flow of each task.

Generally, the communication problem can be formulated as an optimization problem as shown below in Equation (1) and (2):

Max H(x) (1)

s·t·Vol(x) over t<I (2)

where II(x) measures the information content of the upload data, Vol(x) measures the information volume uploaded to the server and I is the cap on the amount of data uploaded. Specifically, the Equations formulate H(x) as the Vol(Hull(f(x_1), f(x_2), . . . , f(x_n))), where f(x_t) is the discriminative feature of each data point x_i, the Hull(.) is the convex hull of the feature vectors f(x_t) and the Vol(.) is the volume of the convex hull.

To select the feature vectors with a maximum volume of the corresponding convex hull, the problem itself would be NP-hard. Therefore, the example embodiments provide an approximation solution. In this example, to implement such a method, the collocated edge devices may maintain a hierarchical cluster of the incoming data. An example of the clustering is shown in FIG. 3A where incoming data is converted into data points mapped as a data pattern over time. Here, three clusters 310, 320, and 330 that occur over three periods of time t1, t2, and t3, respectively, are identified from the graph 300A.

In this example, a slice 302 of the data is taken and transmitted to the cloud platform, while the remaining data is not transmitted. In particular, all data 311 from the first cluster 310 is held by the edge device and not transmitted to the cloud platform. Meanwhile, slice data 322 and slice data 332 from the second cluster 320 and the third cluster 330, respectively, are transmitted to the cloud platform. Meanwhile, data 321 and data are not sent back to the cloud because they are not different enough from the data already received by the cloud.

For example, the edge and cloud may use message passing to actively maintain the cluster structure, as shown in FIG. 3A. Then at each time t, the data cap I and the current cluster structure will determine one “slice” (the horizontal line 302 in FIG. 3A across clusters) of the hierarchical structure, and the system may upload the “centroid” of the cluster on that slice. Additionally, the selection of the data may be sequential, which means that the temporal dimension matters during the data uploading. For each time t, we compare the current selected clusters with previous times in the stack, t−1, t−2, t−k, to pick the furthest data point in that cluster, measured by Hausdorff distance.

The distance may be detected within a feature space. The feature space is generated based on a transformation of the raw data into a feature space. If there is an outlier the distance will identify and keep it. However, when nothing really happens, the distance will be small enough that the information will not be sent back. To determine the distance between data points, a model may be trained that maps raw data points to feature space. In that feature space, data points that are similar to each other are very close to each other. If there are a lot of data points the similar data points are not very useful. The training of the model may need some manual annotation to identify a distance (what is far and what is close). The axis will be the presence and strength of each individual feature. We will not know what the feature is before we train the model.

The data savings is significant and it depends on specific applications (e.g., 2-3% of the data is sent while 97%-98% is not sent). The value that is provided from each data point can be fine-tuned. A parameter can be used that can be tuned here (a maximum amount of data that can be sent back). If a lot of value from the data points is desired, then the parameter can set the maximum amount/threshold of data to be higher, and vice versa. The constraint can be decided by the user. The user may put harsher constraints on the system when it knows bandwidth is very limited.

FIG. 3B is a graph 300B that illustrates a cluster of data points in Euclidean space in accordance with example embodiments. In this example, a cluster of data points have a center 350 which may be determined based on an average of all data points in the cluster In this example, new data point 352 is received. Here, the edge device may determine a distance 354 between the new data point 352 and the center 350 of the cluster. In some embodiments, the distance is defined as a straight line distance between the given data point 352 and the cluster center 350. The cluster center 350 may be continuously updated online when a new point is added to the cluster. In some embodiment, the data points in the cluster may include all historical data points or all data points over a predetermined period of time. In this example, a Gaussian weight may be applied to all historical data, with the more recent the data being given the higher weight. So the data from a long time ago will have very little impact that can be negligible.

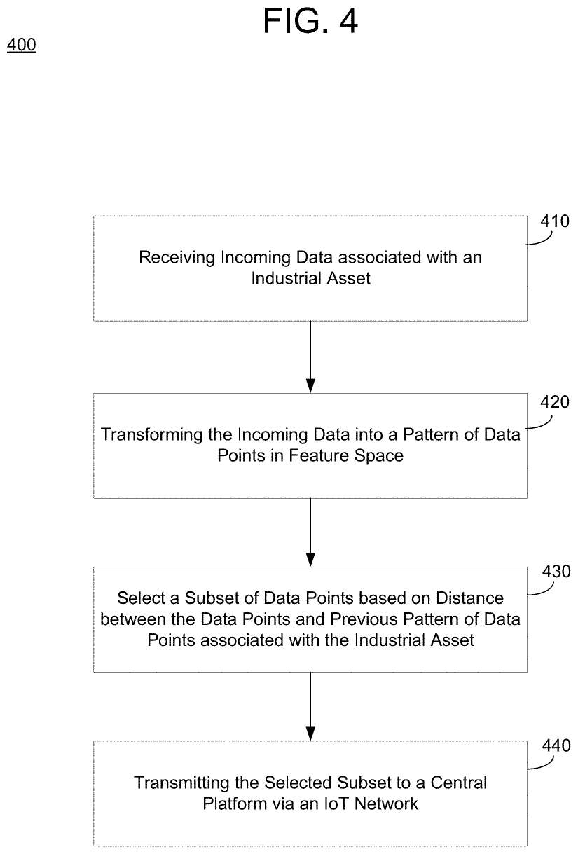

FIG. 4 illustrates a method 400 for selecting a subset of incoming data to be fed back in accordance with an example embodiment. For example, the method 400 may be performed by an edge device such as a computing system connected to or embedded within an industrial asset, a cloud computing platform, web server, a database, and the like, or a combination of devices such as a combination of a cloud platform and an edge computing system. Referring to FIG. 4, in 410 the method may include receiving incoming data which is associated with an industrial asset positioned at an edge of an Internet of Things (IoT) network. For example, the incoming data may include image data captured by an imaging device, and the machine learning model is configured to detect regions of interest of the industrial asset based on the image data. As another example, the incoming data may include time-series data captured by one or more sensors, and the machine learning model is configured to identify changes in an operating characteristic of the industrial asset based on the time-series data.

In 420, the method may include transforming the incoming data into a pattern of data points within a feature space based on a machine learning model configured to detect patterns within the data. For example, the transforming may be performed based on a predetermined threshold size of incoming data, and the predetermined threshold size may be reconfigurable. In some embodiments, the transforming may include transforming the incoming data into a cluster of data points within the feature space, and the selecting may include selecting a slice of data from the cluster of data points in the feature space. In some embodiments, the transforming may be performed in response to determining a predetermined amount of incoming data has been received since a previous cluster transformation occurred.

In 430, the method may include selecting a subset of data points from the pattern based on a distance between data points in the pattern of data points with respect to a previous pattern of data points in a previous dataset associated with the industrial asset, and in 440, the method may include transmitting the selected subset of data points to a central platform via the IoT network. For example, the selecting may include selecting the slice of data based on data points among the plurality of data points that are farthest in distance from a previous cluster of data points associated with the industrial asset. In some embodiments, the method may further include preventing another subset of (or the remaining) data points from being transmitted to the central platform based on a distance between respective data points among the other subset of data points.

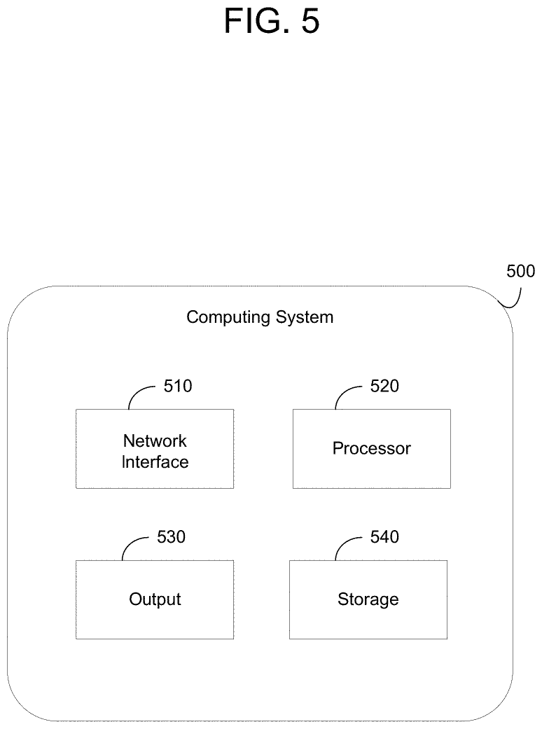

FIG. 5 illustrates a computing system 500 for use in accordance with an example embodiment. For example, the computing system 500 may be an edge computing device, a cloud platform, a server, a database, and the like. In some embodiments, the computing system 500 may be distributed across multiple devices such as both an edge computing device and a cloud platform. Also, the computing system 500 may perform the method 400 of FIG. 4. Referring to FIG. 5, the computing system 500 includes a network interface 510, a processor 520, an output 530, and a storage device 540 such as a memory. Although not shown in FIG. 5, the computing system 500 may include other components such as a display, an input unit, a receiver, a transmitter, and the like.

The network interface 510 may transmit and receive data over a network such as the Internet, a private network, a public network, and the like. The network interface 510 may be a wireless interface, a wired interface, or a combination thereof. The processor 520 may include one or more processing devices each including one or more processing cores. In some examples, the processor 520 is a multicore processor or a plurality of multicore processors. Also, the processor 520 may be fixed or it may be reconfigurable. The output 530 may output data to an embedded display of the computing system 500, an externally connected display, a display connected to the cloud, another device, and the like.

The storage device 540 is not limited to a particular storage device and may include any known memory device such as RAM, ROM, hard disk, and the like, and may or may not be included within the cloud environment. The storage 540 may store software modules or other instructions which can be executed by the processor 520 to perform the method 400 shown in FIG. 4. Also, the storage 540 may store software programs and applications which can be downloaded and installed by a user. Furthermore, the storage 540 may store and the processor 520 may execute an application marketplace that makes the software programs and applications available to users that connect to the computing system 500.

According to various embodiments, the network interface 510 may receive raw data from one on or more sensors attached to or in association with an industrial asset. The sensors may provide images, video, audio, time-series data, and the like, to the computing system 500 for further processing. Here, the computing system 500 may be an edge device such as an industrial server, an edge PC, an asset controller, an on-premises server, and the like. In response, the computing system 500 may store the incoming data within the storage device 540 where it can be processed using one or more ML models executed by the processor 520.

For example, the storage 540 may store incoming data which is associated with an industrial asset positioned at an edge of an IoT network. The processor 520 may transform the incoming data into a pattern of data points within a feature space based on a machine learning model configured to detect patterns within the data, and select a subset of data points from the pattern based on a distance between data points in the pattern of data points with respect to a previous pattern of data points in a previous dataset associated with the industrial asset. Furthermore, the processor 520 may control the network interface 510 to transmit the selected subset of data points to a central platform via the IoT network.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A computing system comprising:
a storage configured to store incoming data which is associated with an industrial asset positioned at an edge of an Internet of Things (IoT) network;
a processor configured to transform the incoming data into a pattern of data points within a feature space based on a machine learning model configured to detect patterns within the data, and select a subset of data points from the pattern based on a distance between data points in the pattern of data points with respect to a previous pattern of data points in a previous dataset associated with the industrial asset; and
a network interface configured to transmit the selected subset of data points to a central platform via the IoT network.

2. The computing system of claim 1, wherein the processor is further configured to prevent another subset of data points from being transmitted to the central platform based on a distance between respective data points among the other subset of data points.

3. The computing system of claim 1, wherein the processor is configured to transform the incoming data into a pattern in the feature space based on a predetermined threshold size of incoming data, and the predetermined threshold size is reconfigurable.

4. The computing system of claim 1, wherein the processor is configured to transform the incoming data into a cluster of data points within the feature space, and select a slice of data from the cluster of data points in the feature space.

5. The computing system of claim 4, wherein the processor is configured to select the slice of data based on data points among the plurality of data points that are farthest in distance from a previous cluster of data points associated with the industrial asset.

6. The computing system of claim 4, wherein the processor is configured to transform the incoming data into the cluster in response to a predetermined amount of incoming data being received since a previous cluster transformation occurred.

7. The computing system of claim 1, wherein the incoming data comprises image data captured by an imaging device, and the machine learning model is configured to detect regions of interest of the industrial asset based on the image data.

8. The computing system of claim 1, wherein the incoming data comprises time-series data captured by one or more sensors, and the machine learning model is configured to identify changes in an operating characteristic of the industrial asset based on the time-series data.

9. A method comprising:
receiving incoming data which is associated with an industrial asset positioned at an edge of an Internet of Things (IoT) network;
transforming the incoming data into a pattern of data points within a feature space based on a machine learning model configured to detect patterns within the data;
selecting a subset of data points from the pattern based on a distance between data points in the pattern of data points with respect to a previous pattern of data points in a previous dataset associated with the industrial asset; and
transmitting the selected subset of data points to a central platform via the IoT network.

10. The method of claim 9, further comprising preventing another subset of data points from being transmitted to the central platform based on a distance between respective data points among the other subset of data points.

11. The method of claim 9, wherein the transforming is performed based on a predetermined threshold size of incoming data, and the predetermined threshold size is reconfigurable.

12. The method of claim 9, wherein the transforming comprises transforming the incoming data into a cluster of data points within the feature space, and the selecting comprises selecting a slice of data from the cluster of data points in the feature space.

13. The method of claim 12, wherein the selecting comprises selecting the slice of data based on data points among the plurality of data points that are farthest in distance from a previous cluster of data points associated with the industrial asset.

14. The method of claim 12, wherein the transforming is performed in response to determining a predetermined amount of incoming data has been received since a previous cluster transformation occurred.

15. The method of claim 9, wherein the incoming data comprises image data captured by an imaging device, and the machine learning model is configured to detect regions of interest of the industrial asset based on the image data.

16. The method of claim 9, wherein the incoming data comprises time-series data captured by one or more sensors, and the machine learning model is configured to identify changes in an operating characteristic of the industrial asset based on the time-series data.

17. A non-transitory computer readable medium storing instructions which when executed are configured to cause a processor to perform a method comprising:
receiving incoming data which is associated with an industrial asset positioned at an edge of an Internet of Things (IoT) network;
transforming the incoming data into a pattern of data points within a feature space based on a machine learning model configured to detect patterns within the data;
selecting a subset of data points from the pattern based on a distance between data points in the pattern of data points with respect to a previous pattern of data points in a previous dataset associated with the industrial asset; and
transmitting the selected subset of data points to a central platform via the IoT network.

18. The non-transitory computer readable medium of claim 17, wherein the method further comprises preventing another subset of data points from being transmitted to the central platform based on a distance between respective data points among the other subset of data points.

19. The non-transitory computer readable medium of claim 17, wherein the transforming is performed based on a predetermined threshold size of incoming data, and the predetermined threshold size is reconfigurable.

20. The non-transitory computer readable medium of claim 17, wherein the transforming comprises transforming the incoming data into a cluster of data points within the feature space, and the selecting comprises selecting a slice of data from the cluster of data points in the feature space.
